(19) United States
(12) Patent Application Publication
(10) Pub. No.: US 2020/0130583 A1
(43) Pub. Date: Apr. 30, 2020

(54) SMART CAMERA MODE INTELLIGENT REARVIEW MIRROR

(71) Applicant: Panasonic Automotive Systems Company of America, Division of Panasonic Corporation or Noth America, Peachtree City, GA (US)

(72) Inventors: PADHU KANAGARAJ, FARMINGTON HILLS, MI (US); STEPHANIE TUTTLE, WALLED LAKE, MI (US)

(73) Assignee: Panasonic Automotive Systems Company of America, Division of Panasonic Corporation or Noth America

(21) Appl. No.: 16/661,584

(22) Filed: Oct. 23, 2019

Related U.S. Application Data
(60) Provisional application No. 62/750,486, filed on Oct. 25, 2018.

(51) Int. Cl. B60R 1/12; B60R 1/04

(52) U.S. Cl. CPC B60R 1/12; B60R 1/04; B60R 2300/105; B60R 2001/1215; B60R 2300/8086; B60R 2001/1253

(57) ABSTRACT

A rearview display arrangement for a motor vehicle includes a rearview image sensor positioned to capture first images of a scene behind the motor vehicle. A rearview display screen has a display mode and a mirror mode, in the display mode, the rearview display screen receives video signals based on the captured first images and displays second images based on the video signals. In the mirror mode, the rearview display screen functions as a rearview mirror. An electronic processing apparatus is communicatively coupled to the rearview image sensor and to the rearview display screen. The electronic processing apparatus detects a fault in the captured first images or in the video signals, and, in response to the detecting, switches the rearview display screen from the display mode to the mirror mode.

### CROSS-REFERENCED TO RELATED APPLICATIONS

This application claims benefit of U.S. Provisional Application No. 62/750,486 filed on Oct. 25, 2018, the disclosure of which is hereby incorporated by reference in its entirety for all purposes.

### FIELD OF THE INVENTION

The disclosure relates to a rearview display system in a motor vehicle, which may be referred to as an interior rearview monitor system (IRMS) or a full display mirror (FDM).

### BACKGROUND OF THE INVENTION

A rearview display system has a camera mounted on a rear portion of the vehicle facing in a rearward direction (e.g., viewing the road behind the vehicle). A display is embedded inside the rearview mirror (which is also called a “half mirror”). The camera captures the video images of the road behind the vehicle and renders the video images on the display. An advantage of this system is that the driver gets an unobstructed view in the rearward direction (e.g., eliminating the headrests, tall rear passengers and any luggage in the back). In addition, a wider view in the rearward direction is provided as compared to a traditional rearview mirror.

The user glances at the rearview mirror to gain situation awareness behind the vehicle. Glance frequency and rate are very rapid in order to maintain situation awareness in all safety relevant areas: the forward roadway, side view mirrors, and rearview mirror.

In current systems, the user can manually switch back and forth between the mirror mode and the display mode. In order for the user to switch the rearview mirror display system mode, they need to press a button located on the bottom of the mirror. The time it takes to switch modes can remove the user's attention and awareness from safety relevant areas.

### SUMMARY

The present invention may enable automatic switching from the display mode to the mirror mode when the rearview camera is obstructed (e.g., by debris or is otherwise physically blocked) or damaged, or when there is no communication from the camera module. The camera module has intelligence in the form of an image signal processor which can detect a bad pixel, white balance, etc. When the camera detects an error, the camera may send a communication message to the rearview display to automatically switch the rearview display to the rearview mirror mode. This can be implemented by monitoring the video signal, fault positive techniques (functional safety element), etc. The camera system may send the information to the rearview mirror/display system to switch the rearview mirror/display system to the mirror mode. A G sensor (e.g., an accelerometer) may be included in the camera module for triggering the microprocessor to check the video signals.

The rearview mirror may also monitor through hardware/software by missing-message strategy. If no video signal is being received, the rearview display may switch to the mirror mode from the display mode.

The rearview module may notify the driver/user via a popup message on the dash display and/or via an LED status indicator (e.g., a red blinking light) stating the display mode is being switched, or has been switched, to mirror mode. If the user attempts to switch back to the rearview mirror display system mode, the error message may be displayed.

In one embodiment, the invention comprises a rearview display arrangement for a motor vehicle, including a rearview image sensor positioned to capture first images of a scene behind the motor vehicle. A rearview display screen has a display mode and a mirror mode. In the display mode, the rearview display screen receives video signals based on the captured first images and displays second images based on the video signals. In the mirror mode, the rearview display screen functions as a rearview mirror. An electronic processing apparatus is communicatively coupled to the rearview image sensor and to the rearview display screen. The electronic processing apparatus detects a fault in the captured first images or in the video signals, and, in response to the detecting, switches the rearview display screen from the display mode to the mirror mode.

In another embodiment, the invention comprises a rearview display method for a motor vehicle, including capturing first images of a scene behind the motor vehicle. A rearview display screen is provided having a display mode and a mirror mode. In the display mode, the rearview display screen is used to display second images dependent on video signals based on the captured first images. In the mirror mode, the rearview display screen is used as a rearview mirror. A fault is detected in the captured first images or in the video signals. In response to the detecting, the rearview display screen is switched from the display mode to the mirror mode.

In yet another embodiment, the invention comprises a rearview display arrangement for a motor vehicle, including a rearview camera positioned to capture first images of a scene behind the motor vehicle. A rearview display screen has a display mode and a mirror mode. In the display mode, the rearview display screen receives video signals based on the captured first images and displays second images based on the video signals. In the mirror mode, the rearview display screen functions as a rearview mirror. A G sensor produces a G sensor signal indicative of forces exerted on the motor vehicle. An electronic processing apparatus is communicatively coupled to the rearview image sensor, to the rearview display screen, and to the G sensor. The electronic processing apparatus, in response to the G sensor signal indicating a force exceeding a threshold level of force, detects a fault in the captured first images or in the video signals. In response to the detecting, the electronic processing apparatus switches the rearview display screen from the display mode to the mirror mode.

An advantage of the present invention is that auto-switching the rearview mirror display system mode during failure eliminates the user task of manually changing the rearview mirror display system mode and reduces the user task time in recognizing the problem and identifying a solution to regain awareness of the situation behind the vehicle. In summary, auto-switching the rearview mirror display system mode during failure removes the troubleshooting task from the user.

### BRIEF DESCRIPTION OF THE DRAWINGS

A better understanding of the present invention will be had upon reference to the following description in conjunction with the accompanying drawings.

FIG. 1 is a block diagram of one example embodiment of a rearview display arrangement of the present invention for a motor vehicle.

FIG. 2 is a block diagram of one example embodiment of the image recognition system of the arrangement of FIG. 1.

FIG. 3 is a flow chart of one example embodiment of a rearview display method of the present invention for a motor vehicle.

### DETAILED DESCRIPTION OF THE PREFERRED EMBODIMENTS

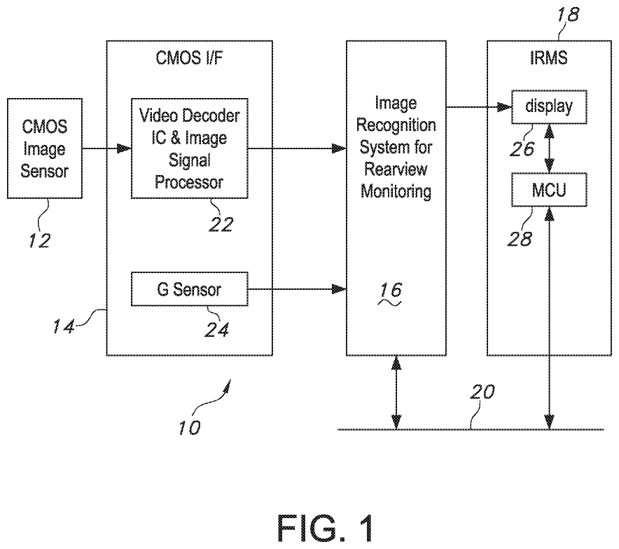

FIG. 1 illustrates one example embodiment of a rearview display arrangement 10 of the present invention installed in a motor vehicle. Arrangement 10 includes a CMOS image sensor 12, a CMOS interface 14, an image recognition system 16 for rearview monitoring, an IRMS 18, and a controller area network (CAN) bus 20.

CMOS image sensor 12 may be in the form of a camera. CMOS interface 14 includes a video decoder integrated circuit and image signal processor 22 and a G sensor 24. Video decoder integrated circuit and image signal processor 22 may identify bad pixels in the captured images; may include a white balance detector; may perform lens shading correction; and may perform Bayer interpolation.

Image recognition system 16 and interface 14 may be included in the same package or housing as sensor 12. Else, image recognition system 16 may be a separate module or may be integrated in IRMS 18, IRMS 18 includes a rearview display 26 and a microcontroller unit (MCU) 28, which may be in bi-directional communication with CAN bus 20.

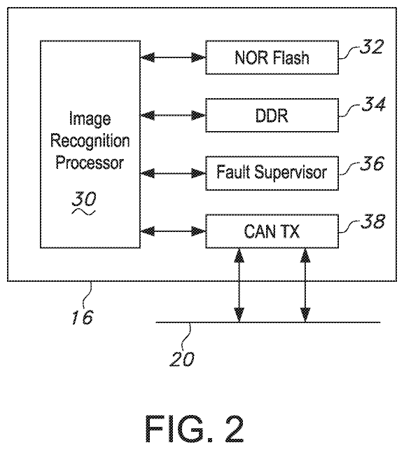

FIG. 2 illustrates the components of image recognition system 16, including an image recognition processor 30, a NOR flash memory device 32, a double data rate (DDR) synchronous dynamic random-access memory device 34, a fault supervisor 36, and a CAN transceiver 38, which may be in bi-directional communication with CAN bus 20.

During use, image sensor 12 captures images of a scene behind the motor vehicle. The captured images are processed by video decoder integrated circuit and image signal processor 22, and the processed images are transmitted to image recognition system 16, along with signals from G sensor 24.

Image recognition system 16 may decide, based on signals received from processor 22 and G sensor 24, whether the image signals from processor 22 are appropriate for presentation on rearview display 26. Particularly, system 16 may evaluate whether the image signals are being received, whether the images show the scene behind the vehicle accurately, and whether the images are of at least a threshold level of quality (e.g., have a number of errors that is low enough). If so, then the image signals are transmitted to rearview display 26 for presentation thereon. If not, then system 16 may automatically switch rearview display 26 to the mirror mode.

In another embodiment, the camera itself detects problems with the images it captures, and, in response, transmits a signal to switch rearview display 26 to mirror mode.

In the event that G sensor 24 detects that the motor vehicle has experienced some type of jolt or high level force impulse, the system may, in response thereto, check the video signal and/or captured images for faults.

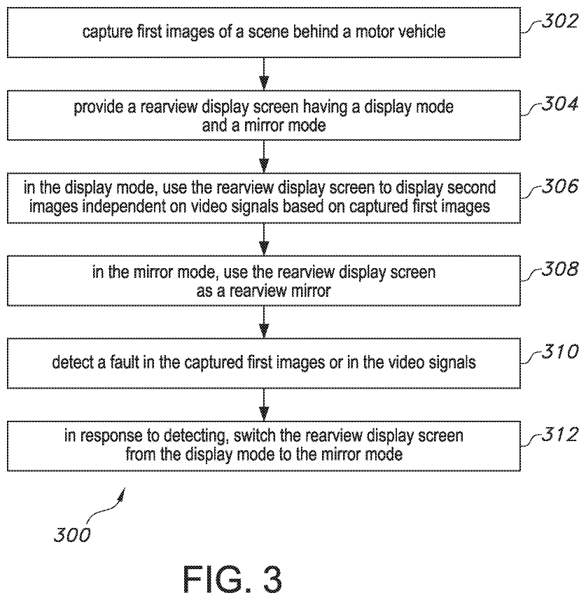

FIG. 3 is a flow chart of one example embodiment of a rearview display method 300 of the present invention for a motor vehicle. The steps may be in a sequential order other than as shown.

In a first step 302, first images of a scene behind the motor vehicle are captured. For example, image sensor 12 may capture images of a scene behind the motor vehicle.

Next, in step 304, a rearview display screen having a display mode and a minor mode is provided. For example, rearview display 26 may be provided having a display mode and a mirror mode.

In a next step 306, in the display mode, the rearview display screen is used to display second images dependent on video signals based on the captured first images. For example, image signals from processor 22, which are dependent upon the images captured by image sensor 12, may be presented on rearview display 26.

In step 308, in the mirror mode, the rearview display screen is used as a rearview mirror. For example, rearview display 26 may have a reflective surface that may be used as a mirror when display 26 is not presenting images based on video signals received by display 26.

Next, in step 310, a fault in the captured first images or in the video signals is detected. For example, image recognition system 16 may detect that the image signals are not being received, that the images do not show the scene behind the vehicle accurately, or that the images are not of at least a threshold level of quality (e.g., have too many errors).

In a final step 312, in response to the detecting, the rearview display screen is switched from the display mode to the mirror mode. For example, in response to the detecting in step 310, system 16 may automatically switch rearview display 26 to the mirror mode.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A rearview display arrangement for a motor vehicle, the arrangement comprising:
a rearview image sensor positioned to capture first images of a scene behind the motor vehicle;
a rearview display screen having a display mode and a mirror mode, the rearview display screen being configured in the display mode to receive video signals based on the captured first images and display second images based on the video signals, the rearview display screen being configured in the mirror mode to function as a rearview mirror; and
an electronic processing apparatus communicatively coupled to the rearview image sensor and to the rearview display screen, the electronic processing apparatus being configured to:
detect a fault in the captured first images or in the video signals; and
in response to the detecting, switch the rearview display screen from the display mode to the mirror mode.

2. The arrangement of claim 1 wherein the rearview image sensor comprises a camera.

3. The arrangement of claim 1 wherein the electronic processing apparatus includes an image signal processor and an image recognition processor communicatively coupled to the image signal processor.

4. The arrangement of claim 1 wherein the fault comprises the video signals not being transmitted.

5. The arrangement of claim 1 wherein the fault comprises the captured first images including an object blocking the scene behind the motor vehicle from the rearview image sensor.

6. The arrangement of claim 1 wherein the fault comprises the video signals including a number of errors exceeding a threshold number.

7. The arrangement of claim 1 further comprising a G sensor communicatively coupled to the electronic processing apparatus and configured to produce a G sensor signal indicative of forces exerted on the motor vehicle, the electronic processing apparatus being configured to check the captured first images and/or the video signals for a fault in response to the G sensor signal indicating a force exceeding a threshold level of force.

8. A rearview display method for a motor vehicle, the method comprising:
capturing first images of a scene behind the motor vehicle;
providing a rearview display screen having a display mode and a mirror mode;
in the display mode, using the rearview display screen to display second images dependent on video signals based on the captured first images;
in the mirror mode, using the rearview display screen as a rearview mirror;
detecting a fault in the captured first images or in the video signals; and
in response to the detecting, switching the rearview display screen from the display mode to the mirror mode.

9. The method of claim 8 wherein the capturing is performed by a camera.

10. The method of claim 8 wherein the detecting is performed by an electronic processing apparatus including an image signal processor and an image recognition processor communicatively coupled to the image signal processor.

11. The method of claim 8 wherein the fault comprises the video signals not being transmitted.

12. The method of claim 8 wherein the fault comprises the captured first images including an object blocking the scene behind the motor vehicle.

13. The method of claim 8 wherein the fault comprises the video signals including a number of errors exceeding a threshold number.

14. The method of claim 8 further comprising:
producing a force signal indicative of forces exerted on the motor vehicle; and
in response to the force signal indicating a force exceeding a threshold level of force, checking the captured first images and/or the video signals for a fault.

15. A rearview display arrangement for a motor vehicle, the arrangement comprising:
a rearview image sensor positioned to capture first images of a scene behind the motor vehicle;
a rearview display screen having a display mode and a mirror mode, the rearview display screen being configured in the display mode to receive video signals based on the captured first images and display second images based on the video signals, the rearview display screen being configured in the mirror mode to function as a rearview mirror;
a G sensor configured to produce a G sensor signal indicative of forces exerted on the motor vehicle; and
an electronic processing apparatus communicatively coupled to the rearview image sensor, to the rearview display screen, and to the G sensor, the electronic processing apparatus being configured to:
in response to the G sensor signal indicating a force exceeding a threshold level of force, detect a fault in the captured first images or in the video signals; and
in response to the detecting, switch the rearview display screen from the display mode to the mirror mode.

16. The arrangement of claim 15 wherein the rearview image sensor comprises a camera.

17. The arrangement of claim 15 wherein the electronic processing apparatus includes an image signal processor and an image recognition processor communicatively coupled to the image signal processor.

18. The arrangement of claim 15 wherein the fault comprises the video signals not being transmitted.

19. The arrangement of claim 15 wherein the fault comprises the captured first images including an object blocking the scene behind the motor vehicle from the rearview image sensor.

20. The arrangement of claim 15 wherein the fault comprises the video signals including a number of errors exceeding a threshold number.
